(19) United States
(12) Patent Application Publication
(10) Pub. No.: US 2022/0246933 A1
(43) Pub. Date: Aug. 4, 2022

(54) FLUORIDE ION SECONDARY BATTERY

(71) Applicant: HONDA MOTOR CO., LTD., Tokyo (JP)

(72) Inventors: Katsutoshi SAKURAI, Saitama (JP); Yoshiyuki MORITA, Saitama (JP)

(21) Appl. No.: 17/583,233

(22) Filed: Jan. 25, 2022

(30) Foreign Application Priority Data
Feb. 2, 2021 (JP) 2021-015006

(51) Int. Cl. H01M 4/58; H01M 4/38; H01M 10/0562

(52) U.S. Cl. CPC H01M 4/582; H01M 2004/027; H01M 10/0562; H01M 4/38

(57) ABSTRACT

Provided is a fluoride ion secondary battery that shows high charging and discharging efficiency even in an environment with an oxygen concentration of more than 2 ppm. The fluoride ion secondary battery includes a positive electrode material layer; a negative electrode material layer; a solid electrolyte layer disposed between the positive electrode material layer and the negative electrode material layer; and an exterior body that accommodates the positive electrode material layer, the negative electrode material layer, and the solid electrolyte layer in a hermetically sealed space filled with an Ar atmosphere. The hermetically sealed space in the exterior body may have an oxygen concentration of 7.3 ppm or less.

This application is based on and claims the benefit of priority from Japanese Patent Application No. 2021-015006, filed on 2 Feb. 2021, the content of which is incorporated herein by reference.

### BACKGROUND OF THE INVENTION

### Field of the Invention

The present invention relates to a fluoride ion secondary battery.

### Related Art

In the conventional art, fluoride ion secondary batteries are proposed using fluoride ions as carriers. Fluoride ion secondary batteries are expected to be superior in performance to lithium-ion secondary batteries, and have been studied in various ways in recent years.

For example, a fluoride ion secondary battery proposed in the conventional art includes a positive electrode; a negative electrode including at least one of metal and a fluoride each including at least La; an ion conducting medium for conducting fluoride ions; and a housing that accommodates the positive electrode, the negative electrode, and the ion conducting medium in a sealed manner (see, for example, Patent Document 1).
Patent Document 1: Japanese Unexamined Patent Application, Publication No. 2017-84506

### SUMMARY OF THE INVENTION

Unfortunately, the conventional fluoride ion secondary battery as disclosed in Patent Document 1 may lose its activity when its electrode active material is oxidized by oxygen during the fluorination and defluorination reactions for charging and discharging. Thus, the conventional fluoride ion secondary battery can operate only when the inside of its housing has an oxygen concentration of 2 ppm or less, and will decrease by half in charging and discharging efficiency during three cycles of charge and discharge, which is significant degradation during the cycles. Accordingly, a need exists to develop a fluoride ion secondary battery that shows high charging and discharging efficiency even in an environment with an oxygen concentration of more than 2 ppm.

The present invention has been made in light of the circumstances mentioned above, and an object of the present invention is to provide a fluoride ion secondary battery that shows high charging and discharging efficiency even in an environment with an oxygen concentration of more than 2 ppm.

(1) An aspect of the present invention is to provide a fluoride ion secondary battery including: a positive electrode material layer; a negative electrode material layer; a solid electrolyte layer disposed between the positive electrode material layer and the negative electrode material layer; and an exterior body that accommodates the positive electrode material layer, the negative electrode material layer, and the solid electrolyte layer in a hermetically sealed space filled with an Ar atmosphere.

(2) In the fluoride ion secondary battery according to aspect (1), the hermetically sealed space in the exterior body has an oxygen concentration of 7.3 ppm or less.

(3) In the fluoride ion secondary battery according to aspect (1), the positive electrode material layer may include Ag, the negative electrode material layer may include at least one of CeF₃ and PbF₂, and the solid electrolyte layer may include LaF₃.

The present invention makes it possible to provide a fluoride ion secondary battery that shows high charging and discharging efficiency even in an environment with an oxygen concentration of more than 2 ppm.

### BRIEF DESCRIPTION OF THE DRAWINGS

FIG. 1 is a view schematically showing the structure of a fluoride ion secondary battery according to a first embodiment of the present invention;

FIG. 2 is a view showing an exemplary method for producing the fluoride ion secondary battery according to the first embodiment;

FIG. 3 is a graph showing the charging and discharging curves of a fluoride ion secondary battery according to Example 1;

FIG. 4 is a graph showing the relationship between the capacity and the square root of the number of cycles with respect to the fluoride ion secondary battery according to Example 1;

FIG. 5 is a graph showing the relationship between the charging and discharging efficiency and the square root of the number of cycles with respect to the fluoride ion secondary battery according to Example 1;

FIG. 6 is a graph showing the charging and discharging curves of fluoride ion secondary batteries according to Examples 1 and 2;

FIG. 7 is a graph showing the time course of the concentration of oxygen in a coin cell case used in Example 2; and

FIG. 8 is a graph showing the relationship between the time, voltage, and current in a charging and discharging test on a fluoride ion secondary battery according to Example 2.

### DETAILED DESCRIPTION OF THE INVENTION

Hereinafter, embodiments of the present invention will be described in detail with reference to the drawings.

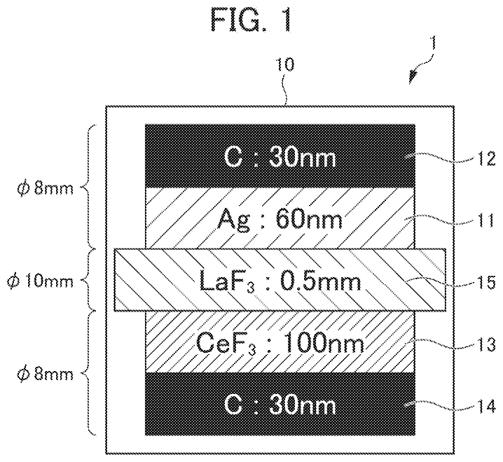

FIG. 1 is a view schematically showing the structure of a fluoride ion secondary battery 1 according to a first embodiment of the present invention. As shown in FIG. 1, the fluoride ion secondary battery 1 according to the embodiment includes a positive electrode material layer 11; a negative electrode material layer 13; a solid electrolyte layer 15 disposed between the positive electrode material layer 11 and the negative electrode material layer 13; and an exterior body 10 that accommodates the positive electrode material layer 11, the negative electrode material layer 13, and the solid electrolyte layer 15 in a hermetically sealed space.

The exterior body 10 may be any type capable of accommodating the positive electrode material layer 11, the negative electrode material layer 13, and the solid electrolyte layer 15 in a hermetically sealed space. The exterior body may be, for example, a laminated film or a coin cell case including a case body and a cap portion.

Alternatively, the exterior body 10 may be a cell manufactured by EC Frontier Co., Ltd. FIG. 1 shows an example in which the exterior body 10 is a coin cell case.

The fluoride ion secondary battery 1 according to the embodiment has the feature that the hermetically sealed space in the exterior body 10 is filled with an Ar atmosphere. In other words, the inside of the exterior body 10 is filled with Ar gas. In this regard, the inside of the exterior body 10 does not need to be evacuated to vacuum and may have an oxygen concentration higher than that in the conventional fluoride ion secondary battery.

Specifically, the hermetically sealed space in the exterior body 10 preferably has an oxygen concentration of 7.3 ppm or less. As mentioned above, the conventional fluoride ion secondary battery can operate only when the inside of the cell has an oxygen concentration of 2 ppm or less, and will decrease by half in charging and discharging efficiency during three cycles of charging and discharging, which is significant degradation during the cycles. In contrast, the fluoride ion secondary battery 1 according to the embodiment holds an Ar atmosphere in the hermetically sealed space in the exterior body 10 and thus can show high charging and discharging efficiency when the hermetically sealed space has an oxygen concentration of 7.3 ppm or less.

The positive electrode material layer 11 includes Ag. Preferably, the positive electrode material layer 11 includes only Ag or consists of Ag. The positive electrode material layer 11 releases fluoride ions F⁻ during discharging and stores fluoride ions F⁻ during charging. The positive electrode material layer 11 including Ag is characterized by being less likely to cause overvoltage at room temperature. The positive electrode material layer 11 including Ag may be formed by, for example, sputtering as described later.

The positive electrode material layer 11 preferably has a thickness of 10 nm or more and less than 120 nm. The positive electrode material layer 11 with a thickness of less than 10 nm may fail to be formed due to particle- or island-like deposition, or may cause undesirable uneven reaction even if successfully formed. The positive electrode material layer 11 with a thickness of more than 120 nm may cause an increase in overvoltage and a decrease in charging and discharging efficiency, which is not desirable. The positive electrode material layer 11 more preferably has a thickness of 10 nm or more and 60 nm or less, even more preferably 10 nm or more and 30 nm or less. FIG. 1 shows an example in which the positive electrode material layer 11 has a thickness of 60 nm.

The negative electrode material layer 13 includes at least one of CeF₃ and PbF₂. The negative electrode material layer 13 preferably includes CeF₃. The negative electrode material layer 13 stores fluoride ions F⁻ during discharging and releases fluoride ions F⁻ during charging. The negative electrode material layer 13 including at least one of CeF₃ and PbF₂ is characterized by being less likely to cause overvoltage at room temperature. The negative electrode material layer 13 including at least one of CeF₃ and PbF₂ may be formed by, for example, sputtering as described later.

The negative electrode material layer 13 preferably has a thickness of 10 nm or more and less than 200 nm. The negative electrode material layer 13 with a thickness of less than 10 nm may fail to be formed due to particle- or island-like deposition, or may cause undesirable uneven reaction even if successfully formed. The negative electrode material layer 13 with a thickness of more than 200 nm may cause an increase in overvoltage and a decrease in charging and discharging efficiency, which is not desirable. The negative electrode material layer 13 more preferably has a thickness of 10 nm or more and 100 nm or less. FIG. 1 shows an example in which the negative electrode material layer 13 has a thickness of 100 nm.

The negative electrode material layer 13 may further include a solid electrolyte including, for example, a fluoride ion-conducting fluoride, and a conductive aid. The negative electrode material layer 13 may further include additional components, such as a binder, as long as such components do not impair the advantageous effects of the embodiment.

The fluoride ion-conducting fluoride may be any fluoride having fluoride ion conductivity. Examples include CeBaFₓ, BaLaF_{y}, and other fluoride ion-conducting fluorides. The negative electrode material layer containing such a fluoride ion-conducting fluoride has improved fluoride ion conductivity.

The conductive aid may be any type having electron conductivity, such as carbon black. Examples of the carbon black include furnace black, Ketjen black, and acetylene black. The negative electrode material layer containing such a conductive aid has improved electron conductivity.

The solid electrolyte layer 15 includes LaF₃. The solid electrolyte layer 15 including LaF₃ has excellent fluoride ion F-conductivity. The solid electrolyte layer 15 including LaF₃ may be a commercially available LaF₃ substrate. The thickness of the solid electrolyte layer 15 is typically, but not limited to, 0.1 mm to 0.5 mm. FIG. 1 shows an example in which the solid electrolyte layer 15 has a thickness of 0.5 mm.

The fluoride ion secondary battery 1 according to the embodiment preferably further includes a positive electrode current collector layer 12 disposed on the outer side of the positive electrode material layer 11. The positive electrode current collector layer 12 may be any type having electron conductivity. For example, the positive electrode current collector layer 12 preferably includes carbon. The positive electrode current collector layer 12 may have any thickness, while FIG. 1 shows an example in which the positive electrode current collector layer 12 has a thickness of 30 nm.

The fluoride ion secondary battery 1 according to the embodiment preferably further includes a negative electrode current collector layer 14 disposed on the outer side of the negative electrode material layer 13. The negative electrode current collector layer 14 may be any type having electron conductivity. For example, when the negative electrode material layer 13 includes CeF₃, the negative electrode current collector 14 preferably includes carbon. When the negative electrode material layer includes PbF₂, the negative electrode current collector layer preferably includes a Pb foil. The negative electrode current collector layer 14 may have any thickness, while FIG. 1 shows an example in which the negative electrode current collector layer 14 has a thickness of 30 nm.

The fluoride ion secondary battery 1 according to the embodiment may have any shape or size. FIG. 1 shows an example in which the exterior body is a cylindrical coin cell case. In the example shown in FIG. 1, the positive electrode material layer 11, the positive electrode current collector layer 12, the negative electrode material layer 13, and the negative electrode current collector layer 14 each have a diameter φ of 8 mm, and the solid electrolyte layer 15 has a diameter φ of 10 mm. The solid electrolyte layer 15 with such a larger diameter prevents short circuit between the positive and negative electrodes.

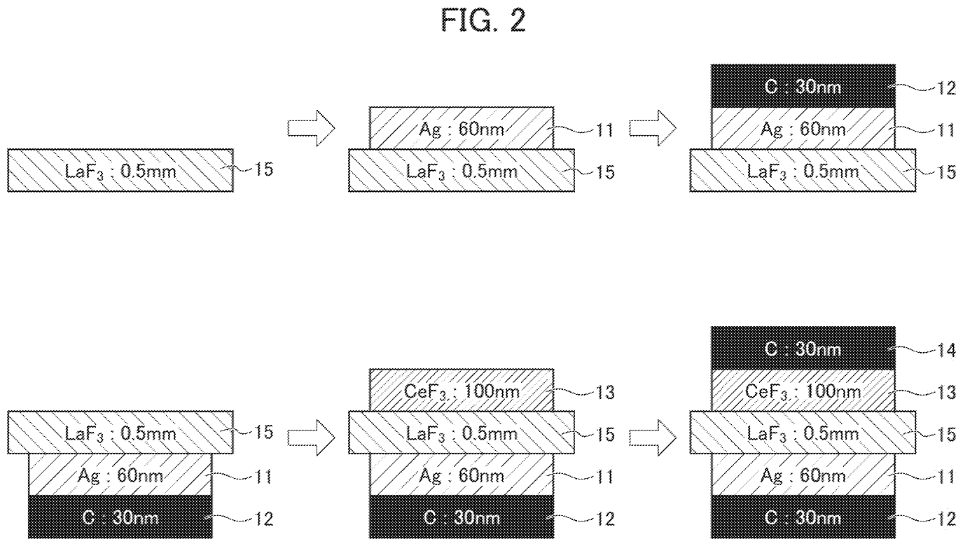

Next, a method for producing the fluoride ion secondary battery according to the embodiment will be described in detail with reference to FIG. 2.

FIG. 2 is a view showing an exemplary method for producing the fluoride ion secondary battery according to the embodiment. As shown in FIG. 2, first, a LaF₃ substrate as a solid electrolyte layer 15 is placed in a predetermined jig (not shown) not exposed to the air (for example, in an environment with a dew point of 80° C. or less and an oxygen concentration of 1 ppm or less). This step may be performed, for example, in a glove box manufactured by UNICO Ltd., in which the environment mentioned above is provided.

The LaF₃ substrate may be a commercially available LaF₃ substrate, such as one manufactured by Pier Optics Co., Ltd. The size of the LaF₃ substrate is, for example, but not limited to, 10 mm in diameter φ and 0.5 mm in thickness. The LaF₃ substrate to be used preferably has a mirror-finished surface.

Subsequently, the LaF₃ substrate set in the jig is transferred into the chamber of a sputtering system while the environment mentioned above is maintained. The sputtering system may be a commercially available sputtering system, such as, Sputtering Equipment EB1000 manufactured by Canon Anelva Corporation. The degree of vacuum in the chamber is, for example, 5×10⁻⁴ Pa or less before the deposition.

Subsequently, DC sputtering is performed using the sputtering system to deposit a positive electrode material layer 11 including Ag on one surface of the LaF₃ substrate as the solid electrolyte layer 15. After the deposition, intermission for a certain period of time is provided.

Subsequently, DC sputtering is performed using the sputtering system to deposit a positive electrode current collector layer 12 including carbon on the deposited positive electrode material layer 11.

Subsequently, the LaF₃ substrate as the solid electrolyte layer 15 with the positive electrode material layer 11 and the positive electrode current collector layer 12 deposited in order on one surface thereof is transferred from the chamber of the sputtering system into the glove box while the environment mentioned above is maintained. After the transfer, the LaF₃ substrate is taken out of the jig, turned upside down, and placed again in the jig with the other surface of the substrate facing upward.

Subsequently, the LaF₃ substrate turned upside down and set again in the jig is transferred into the chamber of the sputtering system while the environment mentioned above is maintained. After the transfer, RF sputtering is performed using the sputtering system to deposit a negative electrode material layer 13 including CeF₃ on the other surface of the LaF₃ substrate as the solid electrolyte layer 15. A similar operation may be used to deposit a negative electrode material layer including PbF₂.

Subsequently, DC spurring is performed using the sputtering system to deposit a negative electrode current collector layer 14 including carbon on the deposited negative electrode material layer 13. A similar operation may be used to deposit a negative electrode current collector layer including a Pb foil.

Subsequently, the LaF₃ substrate as the solid electrolyte layer 15 with the negative electrode material layer 13 and the negative electrode current collector layer 14 deposited in order on the other surface thereof is transferred from the chamber of the sputtering system into the glove box while the environment mentioned above is maintained. After the transfer, the product is subjected to an assembling step including installing it in an exterior body 10, such as a coin cell case or a laminate cell case. Subsequently, Ar gas is introduced into the space in the exterior body 10, which is hermetically sealed, so that the fluoride ion secondary battery 1 according to the embodiment is obtained.

For the deposition of each layer, each deposition rate may be evaluated in advance, and the sputtering time may be adjusted based on the evaluated deposition rates, so that the thickness of each layer may be controlled. Specifically, each sputtering deposition may be performed under certain conditions to form a layer on, for example, a quartz plate partially masked with a masking tape, such as a Kapton tape, attached thereto. Subsequently, the masking tape may be removed, and then the difference in level between the unmasked portion and the portion from which the masking tape has been removed (corresponding to the thickness of the film) is measured with a profile meter. The measurement may be performed under difference conditions for each sputtering deposition, and the results of the measurement may be used to make a calibration curve, from which the deposition rate may be determined. This process makes it possible to control each deposition thickness as desired.

Next, the cell capacity of the fluoride ion secondary battery 1 according to the embodiment will be described. A positive electrode half cell and a negative electrode half cell may each have a capacity as shown below with respect to an example of the fluoride ion secondary battery 1 according to the embodiment shown in FIG. 1 in which the positive electrode material layer 11 including Ag has a thickness of 60 nm and the negative electrode material layer 13 including CeF₃ has a thickness of 100 nm.

Positive Electrode Half Cell

Theoretical capacity: 248 mAh/g
Density: 10.49 g/cm³

### Thickness: 60 nm

Electrode area: 0.5 cm²
Battery capacity: 7.84 μAh

Negative Electrode Half Cell

Theoretical capacity: 408 mAh/g
Density: 6.77 g/cm³

### Thickness: 100 nm

Electrode area: 0.5 cm²
Battery capacity: 12.8 μAh

Regarding the fluoride ion secondary battery 1 according to the embodiment, the cell capacity is determined by the theoretical capacity of the positive electrode, which is lower than that of the negative electrode as shown above. Specifically, the cell capacity of the fluoride ion secondary battery according to the embodiment shown above is determined to be 7.84 μAh (the capacity of the positive electrode), and the N/P ratio is calculated to be 12.8/7.84=1.63.

The fluoride ion secondary battery 1 according to the embodiment having the features described above has advantageous effects as shown below. The fluoride ion secondary battery 1 according to the embodiment includes a positive electrode material layer 11; a negative electrode material layer 13; a solid electrolyte layer 15 disposed between the positive electrode material layer 11 and the negative electrode material layer 13; and an exterior body 10 that accommodates the positive electrode material layer 11, the negative electrode material layer 13, and the solid electrolyte layer 15 in a hermetically sealed space. The hermetically sealed space in the exterior body 10 is filled with an Ar atmosphere. The Ar atmosphere in the hermetically sealed space in the exterior body 10 prevents the electrode active material from losing activity due to oxidation by oxygen during the fluorination and defluorination reactions for charging and discharging. Thus, the fluoride ion secondary battery according to the embodiment can operate and show high charging and discharging efficiency even when the concentration of oxygen in the hermetically sealed space is relatively high. Specifically, the fluoride ion secondary battery according to the embodiment can operate and show high charging and discharging efficiency even when the hermetically sealed space in the exterior body 10 has an oxygen concentration of 7.3 ppm or less.

The fluoride ion secondary battery 1 according to the embodiment may include a positive electrode material layer 11 including Ag; a negative electrode material layer 13 including at least one of CeF₃ and PbF₂; and a solid electrolyte layer 15 including LaF₃ and disposed between the positive electrode material layer 11 and the negative electrode material layer 13. The fluoride ion secondary battery 1 according to the embodiment is constructed using materials that are selected so as to be less likely to cause overvoltage even during room temperature operation of the corresponding half cell in a charging and discharging test and an intermittent charging and discharging test. Even when operated at room temperature, therefore, the fluoride ion secondary battery according to the embodiment can be prevented from suffering from high overvoltage and prevented from degrading during charging and discharging cycles, and can exhibit high charging and discharging efficiency.

The embodiments described above are not intended to limit the present invention and may be altered or modified within the scope of the present invention where the objects of the present invention can be achieved.

### EXAMPLES

Next, examples of the present invention will be described, which are not intended to limit the scope of the present invention.

### Example 1

In Example 1, a fluoride ion secondary battery according to the first embodiment shown in FIG. 1 was prepared according to the production method described above. In Example 1, a hermetically sealed space formed in a coin cell case was evacuated to vacuum and then filled with Ar gas. In this process of Example 1, the concentration of oxygen in the hermetically sealed space in the coin cell case was set to 2 ppm or less. The prepared fluoride ion secondary battery of Example 1 was subjected to a constant-current (CC) charging and discharging test under the conditions shown below.

The CC charging and discharging test was performed under vacuum (1×10⁻⁴ Pa or less) at room temperature 25° C. The cell capacity of the fluoride ion secondary battery of Example 1 is determined by the theoretical capacity (248 mAh/g) of the positive electrode, which includes Ag with a theoretical capacity lower than that of CeF₃ in the negative electrode. Thus, the current load was 400 nA, which corresponds to 1/20 C of the theoretical capacity (248 mAh/g) of the positive electrode including Ag. The current load corresponds to about 0.8 μA/cm² per unit area since the area of the cell of Example 1 is about 0.5 cm². The cut-off condition was a cut-off voltage of 1.0 to 4.2 V or a cut-off time of 20 hours. Intermission for 10 minutes was provided at switching between charging and discharging.

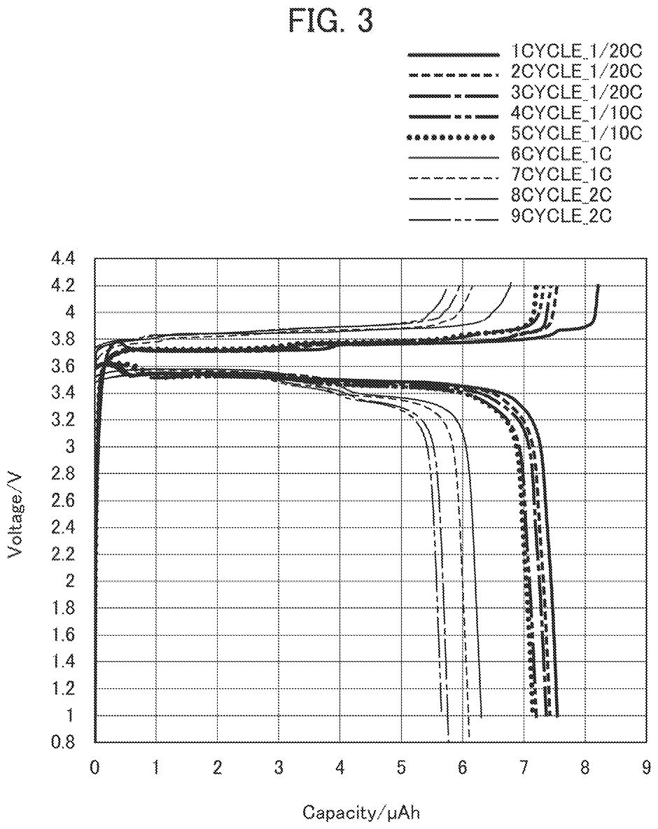

The charging and discharging test procedure was as follows. A rate test was performed during the first 10 cycles. Specifically, the rate was gradually increased such that the rate was 1/20 C during 1st to 3rd cycles, 1/10 C during 4th and 5th cycles, 1 C during 6th and 7th cycles, and 2 C during 8th and 9th cycles. After the rate test, a 100-cycle charging and discharging test was performed at a constant rate of 1 C. In the middle of the test, the rate was changed to 1/20 C for the check of the charging and discharging capacity. The results of the charging and discharging test are shown in FIGS. 3 to 5.

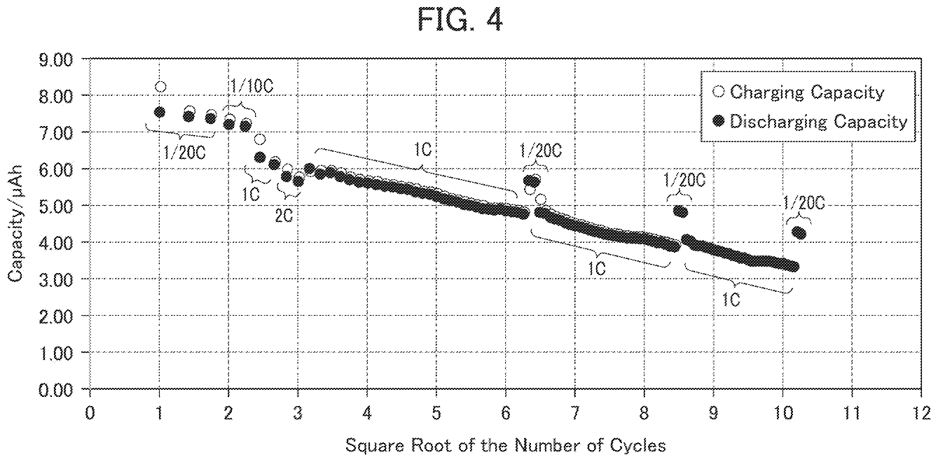

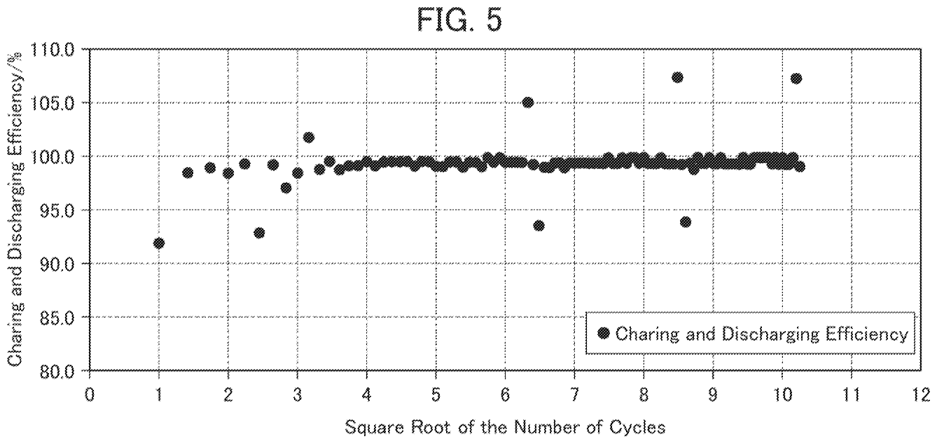

FIG. 3 is a graph showing the charging and discharging curves of the fluoride ion secondary battery of Example 1. FIG. 4 is a graph showing the relationship between the capacity and the square root of the number of cycles with respect to the fluoride ion secondary battery of Example 1. FIG. 5 is a graph showing the relationship between the charging and discharging efficiency and the square root of the number of cycles with respect to the fluoride ion secondary battery of Example 1. FIG. 3 shows the charging and discharging curves obtained during the first 10-cycle rate test. FIGS. 4 and 5 show the charging and discharging capacity and the charging and discharging efficiency obtained in the rate test and in the 100-cycle charging and discharging test after the rate test.

FIGS. 3 to 5 indicate that the fluoride ion secondary battery of Example 1 can operate at room temperature. At room temperature, the initial charging and discharging efficiency is 90%, and 77% of the discharging capacity at 0.05 C remains at 2 C, which show good rate characteristics. At room temperature, the charging and discharging efficiency during the charging and discharging cycles at 1 C was found to be 99%, and the capacity retention after the 100 cycles of charging and discharging was found to be 50%. Those results show that the fluoride ion secondary battery of Example 1 has high charging and discharging efficiency at room temperature.

### Example 2

In Example 2, a fluoride ion secondary battery according to the first embodiment shown in FIG. 1 was prepared according to the production method described above. In Example 2, a hermetically sealed space formed in a coin cell case was not evacuated to vacuum and but filled with Ar gas. The prepared fluoride ion secondary battery of Example 2 was subjected to a constant-current (CC) charging and discharging test under the same conditions as those in Example 1.

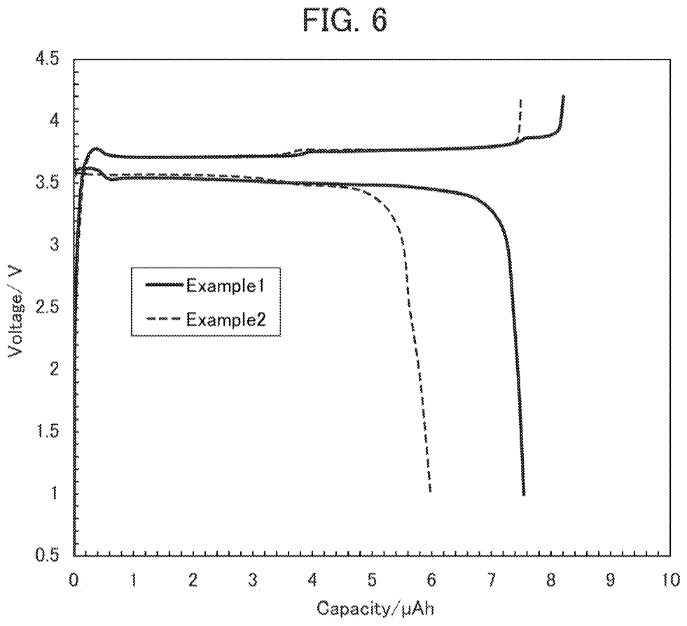

FIG. 6 is a graph showing the charging and discharging curves of the fluoride ion secondary batteries of Examples 1 and 2. FIG. 6 indicates that the fluoride ion secondary battery of Example 2 can operate as well as that of Example 1 since the hermetically sealed space in its case is filled with an Ar atmosphere as in Example 1 despite no evacuation.

The fluoride ion secondary battery of Example 2 was examined with respect to the time course of the concentration of oxygen in the coin cell case. Specifically, after the preparation, the fluoride ion secondary coin cell battery of Example 2 was allowed to stand in the air, and two days and three days after the preparation, the amount of oxygen leaked in the coil cell was determined. The amount of oxygen leaked in was measured under the conditions shown below.

Measurement Conditions

Measurement system: TPD-MS system
Airtight box: Special airtight box for package analysis
GC/MS system: GC/MS System QP2010 Plus (10) manufactured by Shimadzu Corporation
Measurement mode: Five minutes after the start of the measurement, the sample was destroyed in the airtight box and TPD-MS analysis was performed on the released gas. Destruction
temperature: Room temperature
MS sensitivity: 0.95 kV
Mass number range: m/z=10 to 300
Atmosphere: He flow (50 mL/min)

### Standard: Air

Data processing: Thermal Analysis System THADAP-TGGC/MS manufactured by TRC

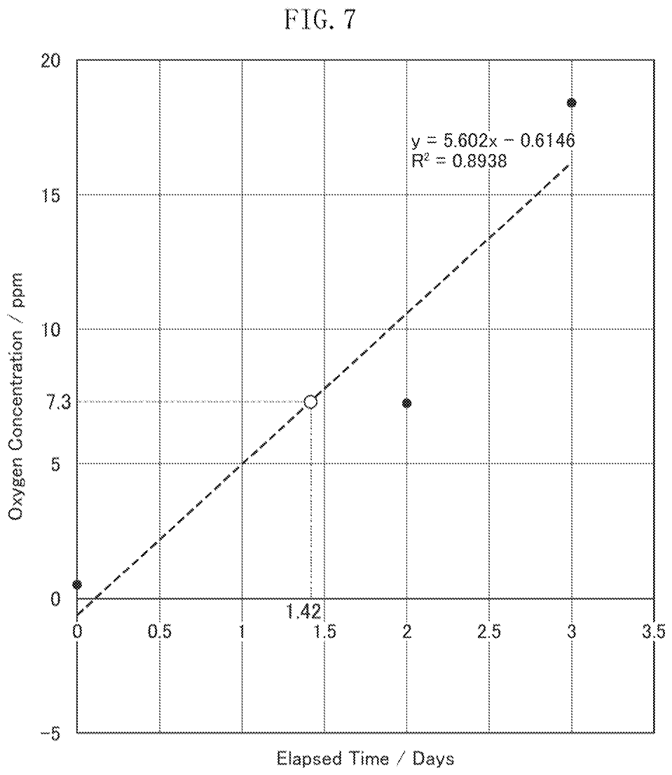

FIG. 7 is a graph showing the time course of the concentration of oxygen in the coin cell case in Example 2. In FIG. 7, the oxygen concentration at day 0 is 0.5 ppm, which is the concentration of oxygen in the glove box in which the assembling of the coin cell was performed. FIG. 7 shows that the oxygen concentration increases with time after 2 days and 3 days, which indicates that oxygen leaks into the coin cell. The results also suggest that an approximate straight line should be available as shown in FIG. 7.

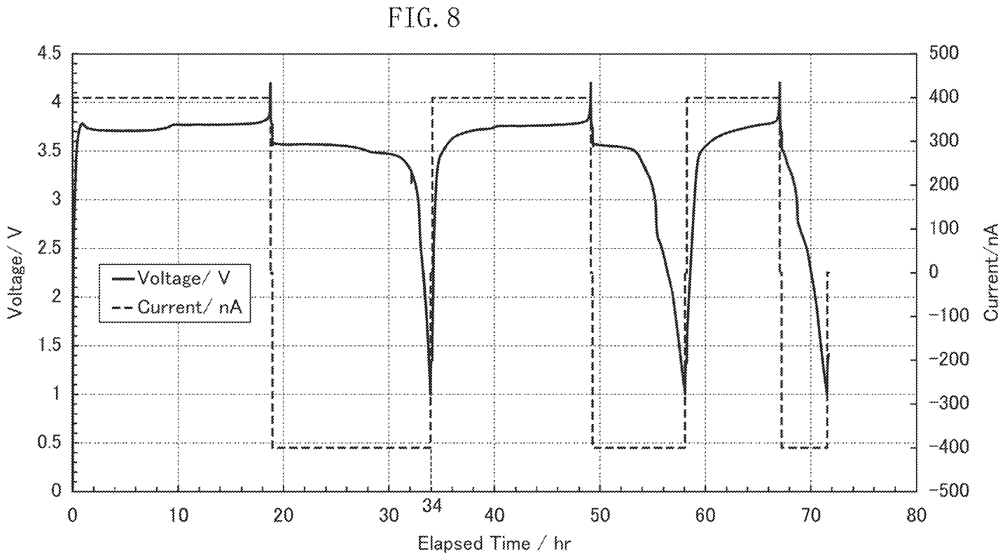

FIG. 8 is a graph showing the relationship between the elapsed time, voltage, and current in the charging and discharging test on the fluoride ion secondary battery of Example 2. FIG. 8 indicates that the initial charging and discharging efficiency in Example 2 is 80% at the first cycle of CC charging and discharging (1/20 C) after the elapse of 34 hours, which means that the fluoride ion secondary battery of Example 2 withstands one cycle. The oxygen concentration after the elapse of 34 hours (1.42 days) was determined from the approximate straight line shown in FIG. 7 to be 7.3 ppm. This suggests that the concentration of oxygen in the hermetically sealed space in the exterior body should preferably be 7.3 ppm or less.

### EXPLANATION OF REFERENCE NUMERALS

1: Fluoride ion secondary battery
10: Exterior body
11: Positive electrode material layer
12: Positive electrode current collector layer
13: Negative electrode material layer
14: Negative electrode current collector layer
15: Solid electrolyte layer

What is claimed is:

1. A fluoride ion secondary battery comprising:
a positive electrode material layer;
a negative electrode material layer;
a solid electrolyte layer disposed between the positive electrode material layer and the negative electrode material layer; and
an exterior body that accommodates the positive electrode material layer, the negative electrode material layer, and the solid electrolyte layer in a hermetically sealed space filled with an Ar atmosphere.

2. The fluoride ion secondary battery according to claim 1, wherein the hermetically sealed space in the exterior body has an oxygen concentration of 7.3 ppm or less.

3. The fluoride ion secondary battery according to claim 1, wherein
the positive electrode material layer comprises Ag,
the negative electrode material layer comprises at least one of CeF₃ and PbF₂, and
the solid electrolyte layer comprises LaF₃.

4. The fluoride ion secondary battery according to claim 2, wherein
the positive electrode material layer comprises Ag,
the negative electrode material layer comprises at least one of CeF₃ and PbF₂, and
the solid electrolyte layer comprises LaF₃.
